(19) United States
(12) Patent Application Publication
(10) Pub. No.: US 2021/0210060 A1
(43) Pub. Date: Jul. 8, 2021

(54) ACOUSTIC ATTENUATION MAT

(71) Applicant: CAREY WIDDER, ST. LOUIS, MO (US)

(72) Inventor: CAREY WIDDER, ST. LOUIS, MO (US)

(21) Appl. No.: 16/734,718

(22) Filed: Jan. 6, 2020

(51) Int. Cl. G10K 11/162

(52) U.S. Cl. CPC G10K 11/162

(57) ABSTRACT

An acoustic attenuation mat for reducing the transference of sound waves between two materials wherein certain embodiments of the invention have a first portion and a second portion where each portion has a difference spring rate and elastic range thereby generating a variable rate compound spring effect that allows embodiments of the invention to support a certain range of weight loading while at the same time provide an ability to attenuate a range of sounds and types of sounds.

### CROSS REFERENCE TO RELATED APPLICATIONS

Not applicable.

### STATEMENT REGARDING FEDERALLY SPONSORED RESEARCH

Not Applicable.

### BACKGROUND OF THE INVENTION

In 2000, the International Building Code (IBC) began including an acoustic standard for impact noise isolation in floor/ceiling assemblies for multi-family residences. That Code has been identified as IBC2000. Multi-family residences include apartments and condominiums as well as hotels, senior living facilities, dormitories, and other student housing. Subsequent to IBC2000, municipalities across the USA have begun adopting this new code and there is pressing need to incorporate engineering designs that meet the requirements of that Code without generating excessive costs in the price of the acoustic attenuation materials or increasing the cost of installation of that material into the construction processes.

Presently, the principle method for meeting these standards has been to install an acoustic mat between a cementitious underlayment and the subfloor. This current acoustic mat serves the purpose of isolating certain impact noises within the cementitious slab from the building structure.

Acoustic mats currently available in the marketplace are generally made from rubber, cork, plastic, foam, and other materials. The most widely used material, however, is a non-woven monofilament entangled mesh with a thin fabric backing.

In addition to these new acoustic standards, the IBC has instituted a fire break standard for many years in floor and ceiling assemblies. Typical construction methods currently in use to achieve both the IBC acoustic rules and the IBC fire break rules incorporate the pouring of a cementitious gypsum concrete underlayment over an acoustic mat.

In addition to the acoustic mat, and for acoustic purposes, the concrete pour is further isolated from the dwelling walls with a thin perimeter foam plastic. Such materials and the installation of those materials results in increased cost for each building constructed under the revised IBC codes.

It has been determined that footfall upon the floor of a building is the major contributor in introducing impact noise to the building's flooring and structural systems. More specifically, the problem is generally the greatest when the finished floor is a hard surface such as tile, vinyl, or wood.

In the field of acoustics and vibration control, an accepted method for attenuating these types of vibrational energy is to use a light spring with appropriate damping as part of a mass-spring-damper system. In that type of construction, the concrete underlayment slab functions as the mass and the acoustic mat functions as the spring and damper. Generally speaking, the lighter the spring, the better the acoustic isolation. A lighter spring, however, has an unfavorable effect on the concrete slab's load-carrying capacity. This is because a lighter spring is not as capable of supporting higher loads.

Current solutions generate this unfavorable effect because they result in an unwanted compromise between floor durability and acoustic performance. That unfavorability is especially pronounced in view of the load capacities currently mandated in the building codes and in generally accepted building design. Therefore, the problem is that acoustic mats soft enough to isolate the impact noise makes the mat insufficient to support the concrete under heavier loads and could result in the cracking of the concrete layer. Current solutions are consequently an undesirable compromise between floor durability and acoustic performance.

For example, current residential building construction standards typically may call for 40 pounds per square foot (PSF) dead load and live load carrying capacity. In addition to a 40 PSF design load, building standards also contemplate a potential 300 pound point load that can be easily generated by important domestic appliances such as gun safes, large refrigerators, pianos, and washing machines. Furthermore, there are acoustic matting systems that comprise multiple layers; however, none are known to have the property whereby the purpose of the lighter spring is to be fully compressed at the dead and live load design capacity of the floor.

Although there are a wide range of current devices that attempt to attenuate the acoustic transference issues noted above, each previous attempt to resolve that problem has come with issues that have not achieved the attenuation of sound waves and vibration energy that is presently needed in the construction industry. It would be very useful to introduce a device that can provide attenuation of sound as is presently required under many local construction rules.

In view of these objectives, it is desirable to design a device that improves upon the current compromise between acoustic performance and floor durability. The present invention addresses that need by a novel acoustic attenuation mat constructed to form a compound spring system rather than a single spring system that is only useful in constructions that require a single, and consequently decreased load capacity.

### SUMMARY OF THE INVENTION

This section provides a general summary of the disclosure, and is not a comprehensive disclosure of its full scope or all of its features. In accordance with the various embodiments of the present invention, this invention relates to an acoustic attenuation mat in which a plurality of uniquely designed geometric elements having load carrying characteristics that are constructed so as to form a compound spring, mass, and damper system wherein the spring rate of each geometric elements can be either constant, variable, or have multiple spring rates within each geometric element.

The end result of certain embodiments of the present invention is that these embodiments provide a quieter, more durable floor for lower cost than current solutions. These embodiments also provide the ability to tune or adjust the properties of the compound spring and damper design to achieve the practitioner's desired acoustic, durability, and cost objectives.

Further areas of applicability will become apparent from the description provided herein. The descriptions in this summary are intended for purposes of illustration only and are not intended to limit the scope or the claims of the present disclosure.

### DESCRIPTION OF THE DRAWINGS

In the accompanying drawings which form part of the specification:

FIG. 1 is a general schematic representation of a current embodiment of a subfloor configuration having a single spring acoustic attenuation matting;

FIG. 2 is a general schematic representation of one embodiment of the present compound spring invention showing a subfloor configuration utilizing that embodiment as acoustic attenuation matting;

FIG. 3 is a cross section perspective view of the arrangement of parts and floor support elements for a typical current floor design;

FIG. 4 is a graph showing the effect that normal floor loading can have on the deflection of current design single spring acoustic met configurations;

FIG. 5 is a graph showing the effect that normal floor loading can have on the deflection of one embodiment of the current invention;

FIG. 6 is a partial perspective view of a first embodiment of the present invention;

FIG. 7 is a vertical cross-section view of a first embodiment of the present invention;

FIG. 8 is a partial perspective view of a second embodiment of the present invention;

FIG. 9 is a vertical cross-section view of a second embodiment of the present invention;

FIG. 10 is a partial perspective view of a third embodiment of the present invention;

FIG. 11 is a vertical cross-section view of a third embodiment of the present invention;

FIG. 12 is a partial perspective view of a fourth embodiment of the present invention;

FIG. 13 is a vertical cross-section view of a fourth embodiment of the present invention;

FIG. 14 is a partial perspective view of a fifth embodiment of the present invention;

FIG. 15 is a vertical cross-section view of a fifth embodiment of the present invention;

FIG. 16 is a partial perspective view of a sixth embodiment of the present invention;

FIG. 17 is a vertical cross-section view of a sixth embodiment of the present invention;

FIG. 18 is a partial perspective view of a seventh embodiment of the present invention;

FIG. 19 is a vertical cross-section view of a seventh embodiment of the present invention;

FIG. 20 is a partial perspective view of an eighth embodiment of the present invention;

FIG. 21 is a vertical cross-section view of an eighth embodiment of the present invention;

FIG. 22 is a partial perspective view of an eighth embodiment of the present invention;

FIG. 23 is a vertical cross-section view of a ninth embodiment of the present invention;

FIG. 24 is a partial perspective view of a ninth embodiment of the present invention;

FIG. 25 is a vertical cross-section view of a ninth embodiment of the present invention;

FIG. 26 is a partial perspective view of a tenth embodiment of the present invention;

FIG. 27 is a vertical cross-section view of a tenth embodiment of the present invention;

FIG. 28 is a partial perspective view of an eleventh embodiment of the present invention;

FIG. 29 is a vertical cross-section view of an eleventh embodiment of the present invention;

FIG. 30 is a partial perspective view of an eleventh embodiment of the present invention;

FIG. 31 is a partial perspective view of a twelfth embodiment of the present invention;

FIG. 32 is a vertical cross section view of a twelfth embodiment of the present invention;

FIG. 33 is a partial perspective view of a twelfth embodiment of the present invention;

FIG. 34 is a partial perspective view of a thirteenth embodiment of the present invention;

FIG. 35 is a vertical cross-section view of a thirteenth embodiment of the present invention;

FIG. 36 is a partial perspective view of a fourteenth embodiment of the present invention;

FIG. 37 is a vertical cross-section view of a fourteenth embodiment of the present invention;

FIG. 38 is a partial perspective view of a fifteenth embodiment of the present invention;

FIG. 39 is a vertical cross-section view of a fifteenth embodiment of the present invention;

FIG. 40 is a partial perspective view of a sixteenth embodiment of the present invention;

FIG. 41 is a vertical cross-section view of a sixteenth embodiment of the present invention;

FIG. 42 is a partial perspective view of a seventeenth embodiment of the present invention; and

FIG. 43 is a vertical cross-section view of a seventeenth embodiment of the present invention.

Corresponding reference numerals indicate corresponding steps or parts throughout the several figures of the drawings.

While specific embodiments of the present invention are illustrated in the above referenced drawings and in the following description, it is understood that the embodiments shown are merely some examples of various preferred embodiments and are offered for the purpose of illustration only, and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF AT LEAST ONE PREFERRED EMBODIMENT OF THE INVENTION

In the following description, numerous specific details are set forth such as examples of some preferred embodiments, specific components, devices, and methods, in order to provide a thorough understanding of embodiments of the present disclosure. It will be apparent to a person of ordinary skill in the art that these specific details need not be exclusively employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill.

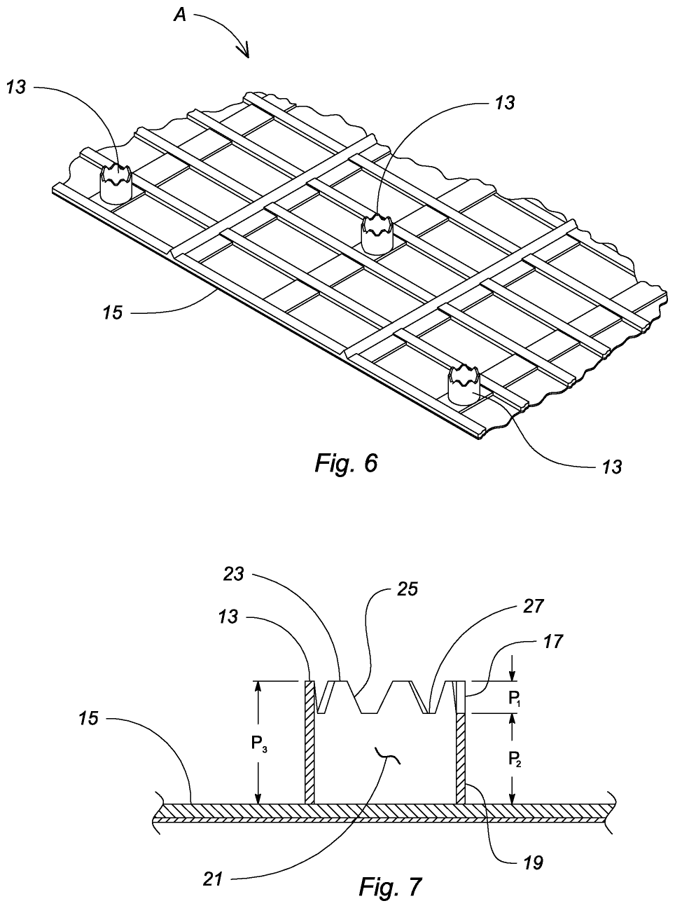

At least one preferred embodiment of the present invention is illustrated in the drawings and figures contained within this specification. More specifically, some preferred embodiments of the present invention are generally disclosed and described in FIGS. 6-47.

Certain embodiments of the invention will operate in the elastic region of a first light spring, providing optimal acoustic isolation when those embodiments are subjected to ordinary residential impact frequencies. At heavier loads, the first light spring will be fully compressed past its elastic range and it and the second heavy spring will provide structural support for the cementitious layer. In some cases, it's also desirable to include damping within the acoustic mat which transforms the vibrational energy into thermal energy.

The acoustic attenuation mat of the certain various embodiments in this invention is constructed with two or more layers of elastic or viscoelastic materials that can be synthetic or natural. It is appreciated by those of skill in the art that a viscoelastic is a material that has the property which exhibits both viscous and elastic characteristics when undergoing deformation. Viscous materials, like honey, resist shear flow and strain linearly with time when a stress is applied. Elastic materials strain when stretched and, depending on the dampening, return to their original state once the stress is removed. Exemplary elastic or viscoelastic materials include, foams, fabrics, fibers, thermoformed sheeting, injection molded materials, press-formed sheeting, or molded sheeting. It is understood that regardless of the material selected, the material would be designed and constructed such that each layer of the material creates has a uniquely designed three-dimensional component that generates a spring-like effect in the direction normal to the structural design and acoustic loading.

Embodiments of the present invention have at least one portion whose vertical spring component has a specific PSF load range. Thus, rather than having a single spring rate, the present invention incorporates a plurality of configurations for a compound spring design that has a first portion, P₁, that has a first lower spring rate than a second portion, P₂, that has a second higher spring rate, and wherein the first portion and the second portion are operatively paired into a single overall portion, P₃. In an exemplary embodiment, the elastic range of this embodiment is such that the first lower spring rate for portion P₁ might be fully compressed at customary distributed design loads (40 PSF), while the second higher spring rate for portion P₂ would only be fully compressed greater than 40 PSF. It is understood that the various embodiments of the present invention can thus be optimized for various desirable combinations of floor durability and acoustic performance requiring an acoustic attenuation mat having elements that incorporates a compound spring effect from the use of at least two portions having different spring rates. It is understood and appreciated by those of skill in the art that the second portion of the preferred embodiments includes a cross section of the second portion that is one of either a regular geometric shape or an irregular shape.

In a multi-layer embodiment, certain embodiments of the present invention can contain at least one first portion acting at a lower spring rate and at least one second portion acting at a higher spring rate wherein the combination of the first portion and the second portion is comparatively rigid. Such embodiments may also include a semi-permeable layer whose function is to keep the cementitious layer from breaching and short-circuiting the compound spring arrangement. The spring effect can be achieved either through careful selection of materials, such as the use of plastic, rubber, and steel, or through the physical form of the mat. Many forms and shapes—geometric and non-geometric—can be used as either the first lower spring rate portion and the second portion having a higher spring rate.

Similarly, many methods of assembling those lower and higher spring rate portions onto a substrate can be used. The final form of each preferred embodiment is dictated by the specific design and requirements of the construction for each unique application. For example, the substrate in some embodiments can either be in continuous web (on rolls) or on individual tiles placed adjacent to each other. It is understood that the design, size, and configuration of the substrate for any particular application may be of any type as long as the acoustic attenuation mat that results from the use of any particular substrate has predictable and consistent multiple spring ranges in the vertical direction.

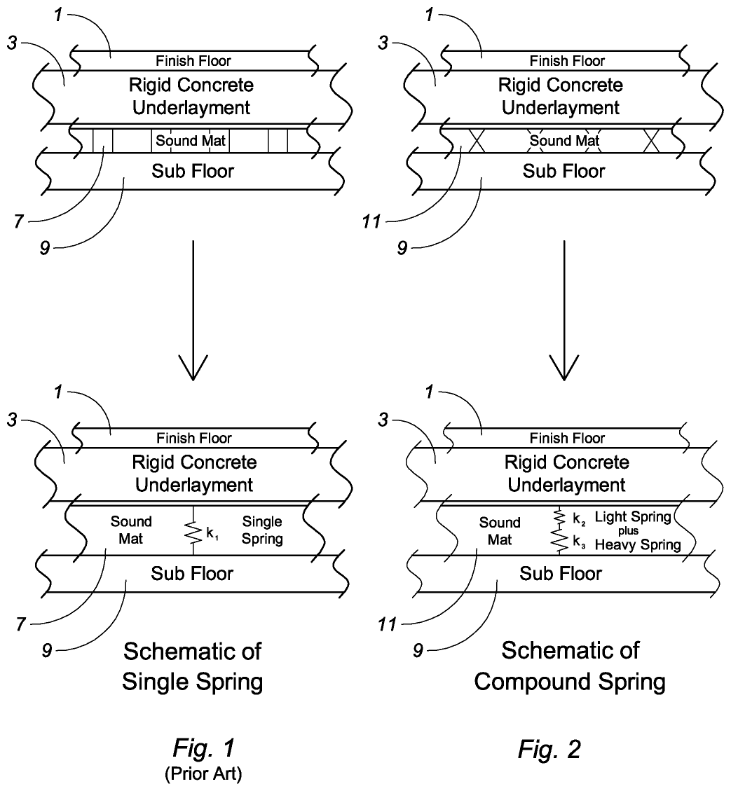

Referring now to FIG. 1, the upper view shows a typical section view of a floor assembly that includes an acoustic mat, commonly known as a “sound mat,” within the design of a floor disposed between a lower and higher floor of a building. In that configuration a finished floor 1 rests upon one of either a rigid concrete underlayment 3 which in turn rests upon a sound mat 7. The sound mat 7 rest upon a subfloor 9 which can be supported by one of many alternative forms of structural flooring support such as floor joists, etc. The lower view of FIG. 1 shows how the current first sound mat usually incorporates a single spring rate K₁ effect to attempt to provide an acoustic attenuation effect between the finished floor 1 and the subfloor 9.

In contrast, FIG. 2 shows one embodiment of the current invention of a finished floor 1 that also rests upon one of either a rigid concrete underlayment 3 wherein the underlayment rests upon the sound mat 11 which in turn rests upon a subfloor. The current embodiment incorporates a second sound mat 11 that does not simply incorporate a single spring rate K₁. Instead, the second sound mat 11 of this embodiment incorporates a compound spring rate having a first portion having a lower spring rate K₂ and a second portion having a higher spring rate K₃.

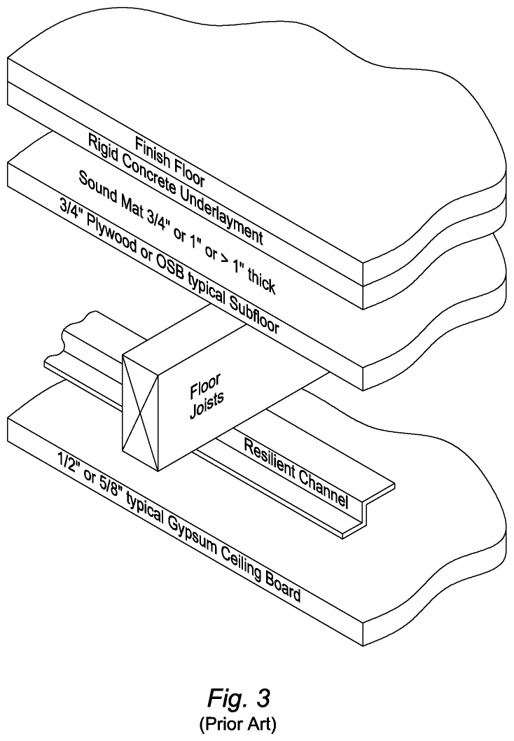

FIG. 3 shows the general construction configuration of a typical floor that is disposed between two floors of a multistory building. It is noted that the floor shown in this figure includes a sound mat positioned between the concrete layer and the subfloor.

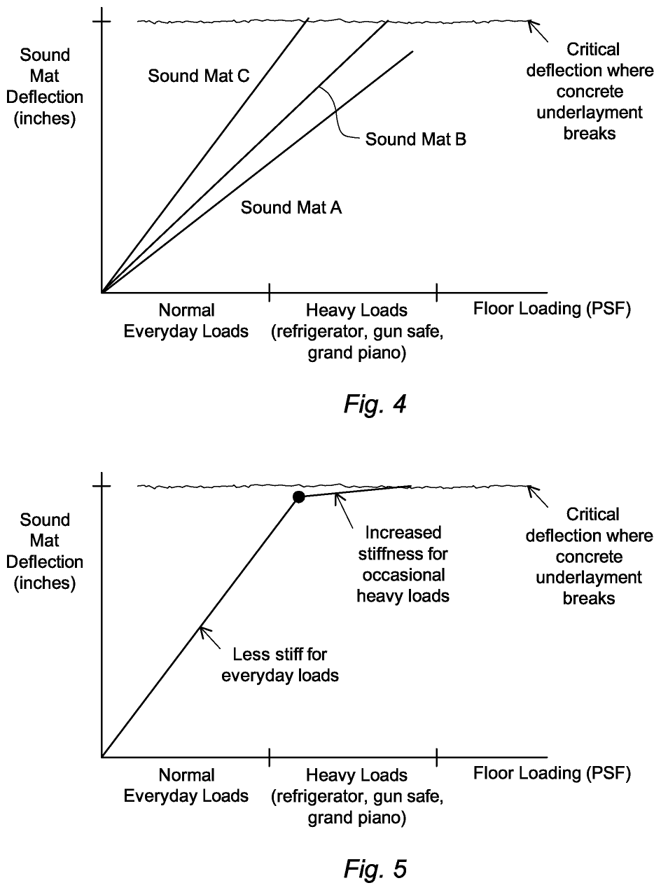

To more readily show the attenuation differences between current sound mats and certain embodiments of the present invention, FIG. 4 and FIG. 5 show a chart that illustrates the problems that arise when a sound mat having a single spring rate is incorporated into the floor design. FIG. 4 shows the general deflection rates and trends when three different types of sound mats A, B, and C are used. As the loads increase in FIG. 4 the deflection of the of the sound mat is substantially linear and proceeds in that manner until the loads applied to the sound mat exceed the load bearing capability of the system of rigid concrete and single spring rate sound mats A, B, and C.

FIG. 5 depicts the relationship between the loads applied to a sound mat having at least two spring rates when such a mat is subjected to various and increasing loads. More specifically, it apparent that as the loads initially increase on the sound mat, the deflection of the sound mat is similar to the current sound mat designs illustrated in FIG. 4. When the load has been increased to a point where the rigid concrete underlayment is in danger of failing, the compound nature of the two spring rates of the sound mat embodiment of the current invention act to delay and extend the load bearing ability of the flooring assembly to prevent failure of the rigid concrete underlayment from cracking or failing due to the brittleness of the concrete material. This load absorption is similar to the effect such brittleness prevention would have on the attenuation of sound when compound spring rates are incorporated into the design of the sound mat. Thus, when the lower spring rate has been placed into full use, the second and higher spring rate acts in a manner that increases the apparent stiffness and load bearing ability of the gypsum to delay or prevent failure of the concrete caused by the brittleness of the concrete material.

Referring now to FIG. 6 and FIG. 7, a first embodiment A of the present invention is shown. In FIG. 6 a plurality of spring elements 13 are disposed on a substrate 15. In this embodiment, the spring elements 13 are generally tubular shaped and have an overall height P₃ as well as an first portion 17 having a lower spring rate value of P₁, and a second portion 19 having a higher spring rate value of P₂. It will be appreciated that the vertical height of either the first portion or the second portion may be of any value and can be selected as needed to meet the loading and attenuation requirements of each specific application. The second portion 19 is in the general form of a tube having a consistent tubular wall thickness and length throughout the height of the second portion. The first portion 17 is also in the generally shape of a tube, however, it is understood that the tube is modified to include a plurality of support elements 21 that have an upper surface 23, an angular element 25, and a lower surface 27.

The construction of the substrate may be of any material as long as the material selected can retain vertical orientation and horizontal spacing of the plurality of spring elements 13. It is understood that the substrate 15 and the plurality of spring elements 13 are preferably constructed of one or two layers of synthetic or natural elastic or viscoelastic materials, and include such materials such as such as foams, fabrics, fibers, or thermoformed, press formed, or molded sheeting. In this embodiment it is further understood and appreciated by those of skill in the art that the style or the combination of geometric shape and material generates a spring-like effect in the vertical direction. In this way, these combinations achieve a compound spring-like effect having a 3-dimensional aspect.

In operation, the present embodiment of the invention would have at least one portion of the plurality of spring elements 13 whose vertical spring constant has a first value within a first range, a damping coefficient within a second range, and a preferred spring constant and elastic range such that the combination of the spring constant and elastic range forms a light spring that might be fully compressed at 40 psf. This effect is in simultaneous operation with the second portion of each of the spring elements that includes at least a second portion having the effect of a higher spring rate within a second range whose elastic range extends above 40 psf.

It is understood that the difference in the geometry and general configuration of the first portion 17 and the second portion 19 is intended to result in the one of either the upper or second portion from being unable to carry more material load PSF than the other portion. It is further understood that while the current embodiment is depicted as having a circular tube shape cross section, yet other tubular cross sections may also be used and remain within the intended scope of the invention. For example, the cross section of the tubular shape may be cylindrical, square-shaped, rectangular shaped, polygonal shaped, oval shaped, arcuately shaped, or irregularly shaped as necessary to meet the specific load requirements and attenuation needs of the specific application of certain embodiments of the invention. Similarly, each of the first portion 17 and the second portion 19 may be of either solid material or of a material having a hollow interior such as a cylinder. The choice of solid or hollow material may be selected as needed for any specific application of the current embodiment and still remain within the intended scope of the invention.

In this embodiment, for example, it is understood that the design of the support element 21 limits the ability of the combination of the upper flat surface, the angular element 25, and the lower flat surface from carrying a heavier load than the more symmetrical and more rigid geometry and configuration of the second portion. This is to say, the general continuous tube-like construction of the second portion 19 is capable of supporting greater loads PSF than the configuration of the first portion 17. That difference in loading ability between the first portion 17 and the second portion 19 allows more flexibility within the first portion than the second portion. That difference is particularly true when it comes to the determination of the maximum load that either the first portion 17 or the second portion 19 can take before the elastic range is exceeded and full deformation of the material from which the upper and second portions are made. In fact, it will be further appreciated by those of skill in the art that the specific selection of material used to make the first portion 17 may be different than the material used to make the lower portion to further differentiate and even enhance the differences in stiffness and flexibility between the upper and second portions. As will be shown in the further embodiments of the present invention, the material used for each portion and the geometric design of each of those portions generate the effect of the compound spring effect of those embodiments.

In the present embodiment, the notched characteristic of the first portion 17 may be of any size and shape as needed to result in the spring rate and flexibility required of the current embodiment based upon the specific application. Although any elastic or viscoelastic material may be used in the construction of the first portion 17 and the second portion 19, the embodiment shown in FIGS. 6 and 7 is substantially constructed using an elastic material such as PVC, polyethylene, or other type of plastic material. It is also understood that the diameter of the second portion 19 can be of any size as along as the size selected will result in the spring rate needed for the embodiment to support the loads and attenuate the specific sound frequencies as required by the specific application. The other general specifications and descriptions for the present embodiment are substantially the same as those noted and described in the first embodiment above.

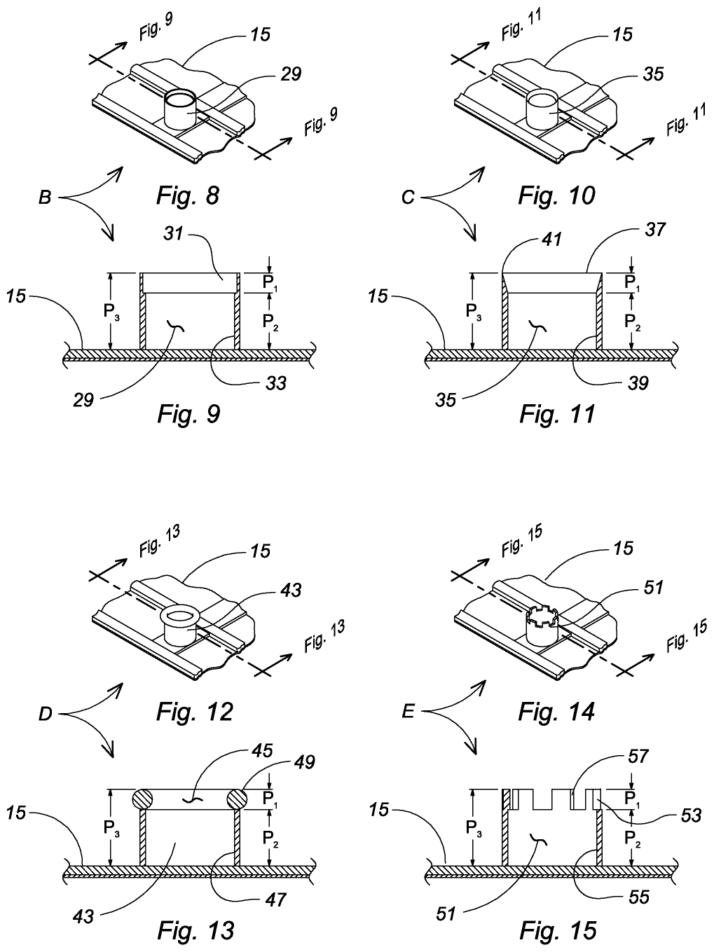

FIG. 8 and FIG. 9 show a 2^{nd} embodiment B of the present invention comprising a substrate 15 similar to the substrate of FIG. 6 & FIG. 7, but comprise a 2^{nd} plurality of spring elements 29 having a different configuration and design. More specifically, the 2^{nd} plurality of spring elements 29 comprises an 2^{nd} first portion 31 and a 2^{nd} second portion 33 wherein the 2^{nd} first portion has a different stiffness and flexibility than the 2^{nd} second portion due to the size and geometric differences between the shape of the 2^{nd} first portion 31 and the 2^{nd} second portion 33. In the present embodiment, the 2^{nd} first portion 31 is generally tubular in shape and has a wall thickness that is thinner than the wall thickness of the 2^{nd} second portion 33. It is understood that the thinner wall thickness of the 2^{nd} first portion makes the 2^{nd} first portion capable of greater sound attenuation for certain frequencies and types of sounds than does the thicker wall thickness of the 2^{nd} second portion 33. The result is a spring element design that has the effect of a compound spring design. The other general specifications and descriptions for the present embodiment are substantially the same as those noted and described in the first embodiment above.

FIG. 10 and FIG. 11 show a 3^{rd} embodiment C of the present invention comprising a substrate 15 again similar to the substrate of FIG. 6 & FIG. 7, but this embodiment comprises a 3^{rd} plurality of spring elements 35 having a different configuration and design. More specifically, the 3^{rd} plurality of spring elements 35 comprises a 3^{rd} first portion 37 and a 3^{rd} second portion 39 wherein the 3^{rd} first portion has a different stiffness and flexibility than the 3^{rd} second portion due to the size and geometric differences between the shape of the 3^{rd} first portion 37 and the 3^{rd} second portion 39. In the present embodiment, the 3^{rd} first portion 37 is generally tubular in shape and has a tapered wall design that extends downward from a vertex 41 to the 3^{rd} second portion 39 such that the wall thickness of the 3^{rd} first portion 37 progressively increases in thickness until the point where the 3^{rd} first portion meets with the 3^{rd} second portion where the wall thickness at that intersection point is equivalent to the wall thickness of the 3^{rd} second portion 39. It is understood that the overall average of the wall thickness of the 3^{rd} first portion 37 is generally less than the average wall thickness of the 3^{rd} second portion 39 thus making the 3^{rd} first portion capable of greater sound attenuation for certain frequencies and types of sounds than does the average thicker wall thickness of the 3^{rd} second portion 39. The result is a spring element design that has the effect of a compound spring design. The other general specifications and descriptions for the present embodiment are substantially the same as those noted and described in the first embodiment above.

FIG. 12 and FIG. 13 show a 4^{th} embodiment D of the present invention comprising a substrate 15 similar to the substrate of FIG. 6 & FIG. 7, but this embodiment comprises a 4^{th} plurality of spring elements 43 having a different configuration and design. More specifically, the 4^{th} plurality of spring elements 43 comprises a 4^{th} first portion 45 and a 4^{th} second portion 47 wherein the 4^{th} first portion has a different stiffness and flexibility than the 4^{th} second portion due to the geometric differences between the shape of the 4^{th} first portion 45 and the 4^{th} second portion 47 and the different material used in the 4^{th} first portion and the 4^{th} second portion. In the present embodiment, the 4^{th} first portion 31 is generally ring-shaped and is made from an elastomeric material that has a much greater resiliency than the material used for the 4^{th} second portion. The general cross section of the 4^{th} first portion of the present embodiment is generally circular, however, it is understood that the cross section other embodiments may be truly circular, toroidal, polygonal, or irregular and still remain within the intended scope of the invention. It is also understood that the material selected and the differences in the shape and material of the 4^{th} first portion makes the 4^{th} first portion capable of greater sound attenuation for certain frequencies and types of sounds than does the shape and material of the 4^{th} second portion 47. The result is a spring element design that again has the effect of a variable rate compound spring design. The other general specifications and descriptions for the present embodiment are substantially the same as those noted and described in the first embodiment above.

FIG. 14 and FIG. 15 show a 5^{th} embodiment E of the present invention comprising a substrate 15 similar to the substrate of FIG. 6 & FIG. 7, but this embodiment comprises a 5^{th} plurality of spring elements 51 having a different configuration and design. More specifically, the 5^{th} plurality of spring elements 51 comprises a 5^{th} first portion 53 and a 5^{th} second portion 55 wherein the 5^{th} first portion has a different stiffness and flexibility than the 5^{th} second portion due to the size and geometric differences between the shape of the 5^{th} first portion and the 5^{th} second portion. In the present embodiment, the 5^{th} first portion 53 is generally tubular in shape and is configured to include a plurality of rectangular notches 57 that provide alternating open and closed portions of the 5^{th} first portion material. The wall thickness of the 5^{th} first portion 53 in the present embodiment is substantially the same as the wall thickness of the 5^{th} second portion 55.

It is understood that the plurality of rectangular notches 57 generate a difference in the geometry and general configuration of the 5^{th} first portion 53 and the 5^{th} second portion 55 that is intended to result in the one of either the upper or second portion from reaching its elastic limit for a given load PSF than the other portion. Similar to other embodiments, that difference in loading ability between the 5^{th} first portion 53 and the 5^{th} second portion 55 allows lesser stiffness within the 5^{th} first portion than the 5^{th} second portion. The result is once again a spring element design that has the effect of a compound spring design. The other general specifications and descriptions for the present embodiment are substantially the same as those noted and described in the first embodiment above.

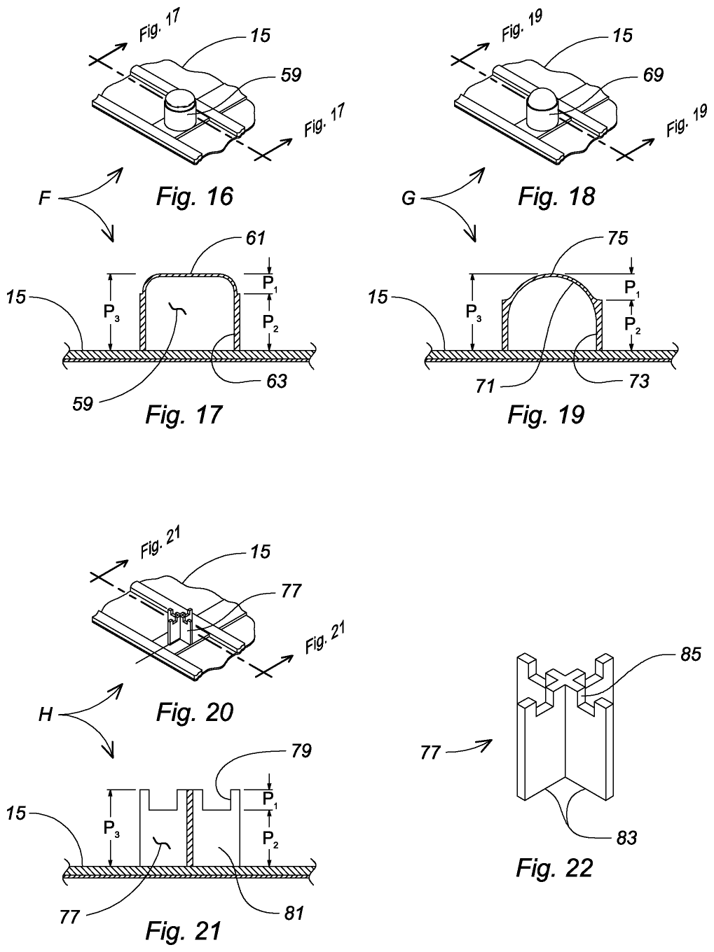

FIG. 16 and FIG. 17 show a 6^{th} embodiment F of the present invention comprising a substrate 15 similar to the substrate of FIG. 6 & FIG. 7, but this embodiment comprises a 6^{th} plurality of spring elements 59 having a different configuration and design. More specifically, the 6^{th} plurality of spring elements 59 comprises a 6^{th} first portion 61 and a 6^{th} second portion 63 wherein the 6^{th} first portion has a different stiffness and flexibility than the 6^{th} second portion due to the size and geometric differences between the shape of the 6^{th} first portion 61 and the 6^{th} second portion 63. In the present embodiment, the 6^{th} first portion 61 is generally bulbous-shaped having a substantially flat upper bulb portion 65 that rests upon substantially vertical second portions 67 shape wherein the entire bulbous shape is generally constructed to have a wall thickness that is thinner than the wall thickness of the 6^{th} second portion 63. It is understood that the thinner wall thickness of the 6^{th} first portion, when combined with the generally bulbous shape of the 6^{th} first portion, makes the 6^{th} first portion capable of greater sound attenuation for certain frequencies and types of sounds than does the thicker wall thickness and overall geometric design of the 6^{th} second portion 63. The result is a spring element design that again has the effect of a compound spring design. The other general specifications and descriptions for the present embodiment are substantially the same as those noted and described in the first embodiment above.

FIG. 18 and FIG. 19 show a 7^{th} embodiment G of the present invention comprising a substrate 15 similar to the substrate of FIG. 6 & FIG. 7, but this embodiment comprises a 7^{th} plurality of spring elements 69 having a different configuration and design. More specifically, the 7^{th} plurality of spring elements 69 comprises a 7^{th} first portion 71 and a 7^{th} second portion 73 wherein the 7^{th} first portion has a different stiffness and flexibility than the 7^{th} second portion due to the size and geometric differences between the shape of the 7^{th} first portion 71 and the 7^{th} second portion 73. In the present embodiment, the 7^{th} first portion 71 is generally arcuate shape having a substantially arcuate bulb portion 75 that rests upon the 7^{th} second portion 73. It is understood that the generally arcuate bulb portion of the 7^{th} first portion, makes the 7^{th} first portion capable of greater sound attenuation for certain frequencies and types of sounds than does the overall geometric design of the 7^{th} second portion 73. The result is a spring element design that again has the effect of a compound spring design. The other general specifications and descriptions for the present embodiment are substantially the same as those noted and described in the first embodiment above.

FIG. 20, FIG. 21, and FIG. 22 show an 8^{th} embodiment H of the present invention comprising a substrate 15 similar to the substrate of FIG. 6 & FIG. 7, but this embodiment comprises an 8^{th} plurality of spring elements 77 having a different configuration and design. It is noted that each of the first section and the second section has a set of arms 83. The 8^{th} plurality of spring elements has an 8^{th} first portion and an 8^{th} second portion. The 8^{th} first portion includes the set of arms 83 of the cross in which each of the arms has a 2^{nd} notch 85. It is understood that in the present embodiment the 8^{th} second portion does not have those 2^{nd} notches 85.

It is understood that the series of 2^{nd} notches 85 of the 8^{th} first portions makes the 8^{th} first portion 79 capable of greater sound attenuation for certain frequencies and types of sounds than does the 8^{th} second portion 81 which does not contain any 2^{nd} notches 85. The result is a spring element design that again has the effect of a compound spring design. The other general specifications and descriptions for the present embodiment are substantially the same as those noted and described in the first embodiment above.

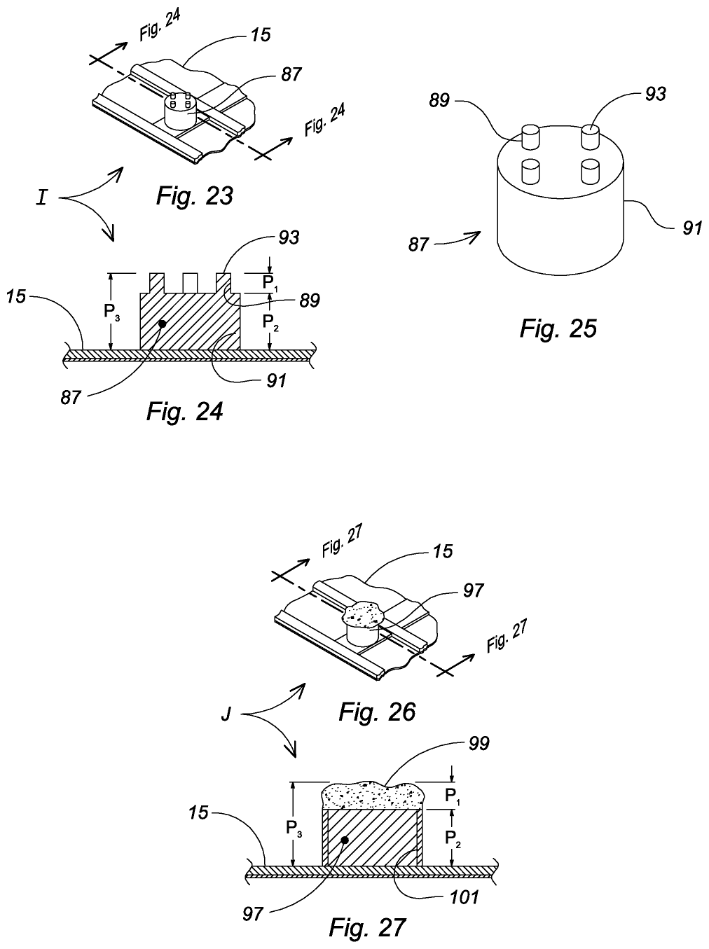

FIG. 23, FIG. 24, and FIG. 25 show a 9^{th} embodiment I of the present invention comprising a substrate 15 similar to the substrate of FIG. 6 & FIG. 7, but this embodiment comprises a 9^{th} plurality of spring elements 87 having a different configuration and design. More specifically, the 9^{th} plurality of spring elements 87 comprises a 9^{th} first portion 89 and a 9^{th} second portion 91 wherein the 9^{th} first portion has a different stiffness and flexibility than the 9^{th} second portion due to the geometric differences between the 9^{th} first portion 89 and the 9^{th} second portion 91.

In the present embodiment, the 9^{th} first portion 89 comprises a plurality of protrusions 93 that are disposed upon an upper surface 95 of the 9^{th} second portion 91. The 9^{th} second portion 91 is also shown as having a generally circular cross shape. It is understood that while the plurality of protrusions 93 and the 9^{th} second portion 91 are generally circular shaped the current embodiment, yet other cross sections may also be used and remain within the intended scope of the invention. For example, the cross section of the plurality of protrusions 93 may be cylindrical, square-shaped, rectangular shaped, polygonal shaped, oval shaped, arcuately shaped, or irregularly shaped as necessary to meet the specific load requirements and attenuation needs pf the specific application of certain embodiments of the invention.

It is understood that the surface area and shape of the 9^{th} first portion 89 is smaller than the cross-sectional area the 9^{th} second portion 91 thus making the 9^{th} first portion capable of greater sound attenuation for certain frequencies and types of sounds than does the greater area of the 9^{th} second portion 91. The result is a spring element design that again has the effect of a compound spring design. The other general specifications and descriptions for the present embodiment are substantially the same as those noted and described in the first embodiment above.

FIG. 26 and FIG. 27, show a 10^{th} embodiment J of the present invention comprising a substrate 15 similar to the substrate of FIG. 6 & FIG. 7, but this embodiment comprises a 10^{th} plurality of spring elements 97 having a different configuration and design. It will be appreciated by those of skill in the art that the spring elements 97 may either be solid or hollow depending on the specific application. More specifically, the 10^{th} plurality of spring elements 97 comprises a 10^{th} first portion 99 and a 10^{th} second portion 101 wherein the 10^{th} first portion has a different stiffness and flexibility than the 10^{th} second portion due to the size and geometric differences between the shape of the 10^{th} first portion 99 and the 10^{th} second portion 101.

In the present embodiment, the 10^{th} first portion 99 generally comprises a quantity of elastomeric material having an irregular shape, but being sized to rest upon the 10^{th} second portion 101. It is understood that the elastomeric material of the 10^{th} first portion 99 is more resilient and flexible than the material used for making the 10^{th} second portion 101. The result is that the greater resiliency of the 10^{th} first portion 99 makes the 10^{th} first portion capable of greater sound attenuation for certain frequencies and types of sounds than does the 10^{th} second portion 101. The result is a spring element design that again has the effect of a compound spring design. The other general specifications and descriptions for the present embodiment are substantially the same as those noted and described in the first embodiment above.

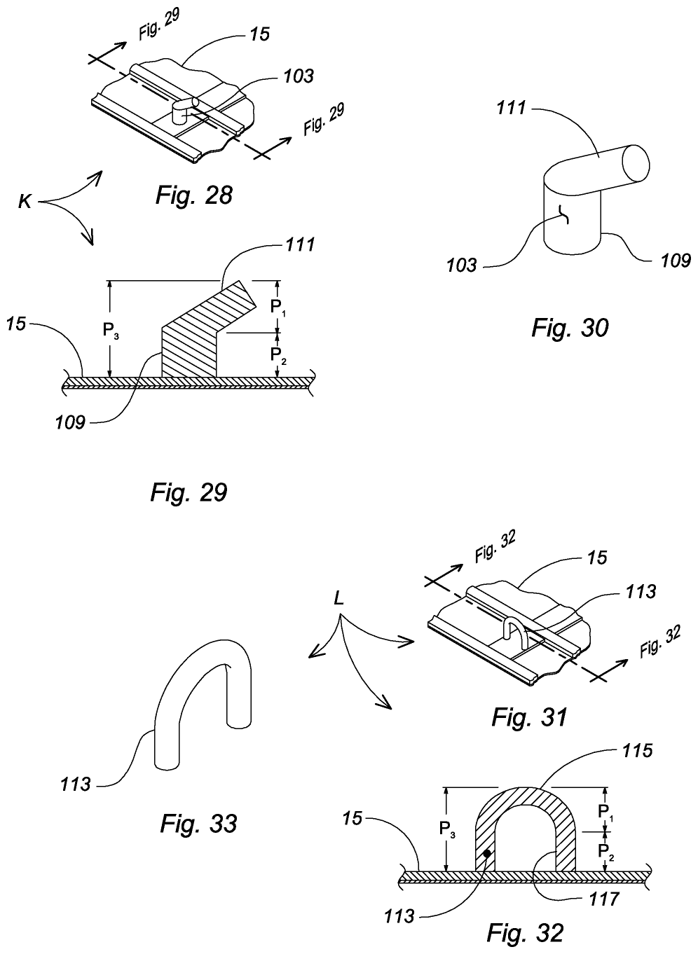

FIG. 28, FIG. 29, and FIG. 30 show a 11^{th} embodiment K of the present invention comprising a substrate 15 similar to the substrate of FIG. 6 & FIG. 7, but this embodiment comprises a 11^{th} plurality of spring elements 103 having a different configuration and design. More specifically, the 11^{th} plurality of spring elements 103 comprises a 11^{th} first portion 105 and a 11^{th} second portion 107 wherein the 11^{th} first portion has a different stiffness and flexibility than the 11^{th} second portion due to the size and geometric differences between the shape of the 11^{th} first portion 105 and the 11^{th} second portion 107. In the present embodiment, the 11^{th} first portion 105 comprises a base 109 and a support 111. In the present embodiment, the support 111 resides on an upper face of the base 109 such that the support makes an obtuse angle with the base. The support 111 is more flexible and resilient and thus more capable of greater sound attenuation for certain frequencies and types of sounds than the base 109. The result is a spring element design that again has the effect of a compound spring design.

It is understood that the obtuse angle, the selection of material used, the values of the cross sectional areas of the base 109 and support 111 may be of any value as long as the result is that the combination of the 11^{th} first portion 105 and the 11^{th} second portion 107 has the effect of a compound spring assembly. It is also appreciated that the cross-sectional shape of the base 109 and the support 111 may be of any geometric form and still remain within the scope of the present invention. The other general specifications and descriptions for the present embodiment are substantially same as those noted and described in the first embodiment above.

FIG. 31, FIG. 32, and FIG. 33 show a 12^{th} embodiment L of the present invention comprising a substrate 15 similar to the substrate of FIG. 6 & FIG. 7, but this embodiment comprises a 12^{th} plurality of spring elements 113 having a different configuration and design. More specifically, the 12^{th} plurality of spring elements 113 comprises a 12^{th} first portion 115 and a 12^{th} second portion 117 wherein the 12^{th} first portion has a different stiffness and flexibility than the 12^{th} second portion due to the size and geometric differences between the shape of the 12^{th} first portion 115 and the 12^{th} second portion 117.

In the present embodiment, the 12^{th} first portion 115 is generally U-shaped. The 12^{th} first portion 115 comprises the arcuate portion of the U-shape and the 12^{th} second portion 117 comprises the vertical portions of the U-shape. It is understood that the arcuate portion of the U-shape makes the 12^{th} first portion 113 capable of greater sound attenuation for certain frequencies and types of sounds than does the vertical portions of the U-shape of the 12^{th} second portion 115. The result is a spring element design that again has the effect of a compound spring design. The other general specifications and descriptions for the present embodiment are substantially the same as those noted and described in the first embodiment above.

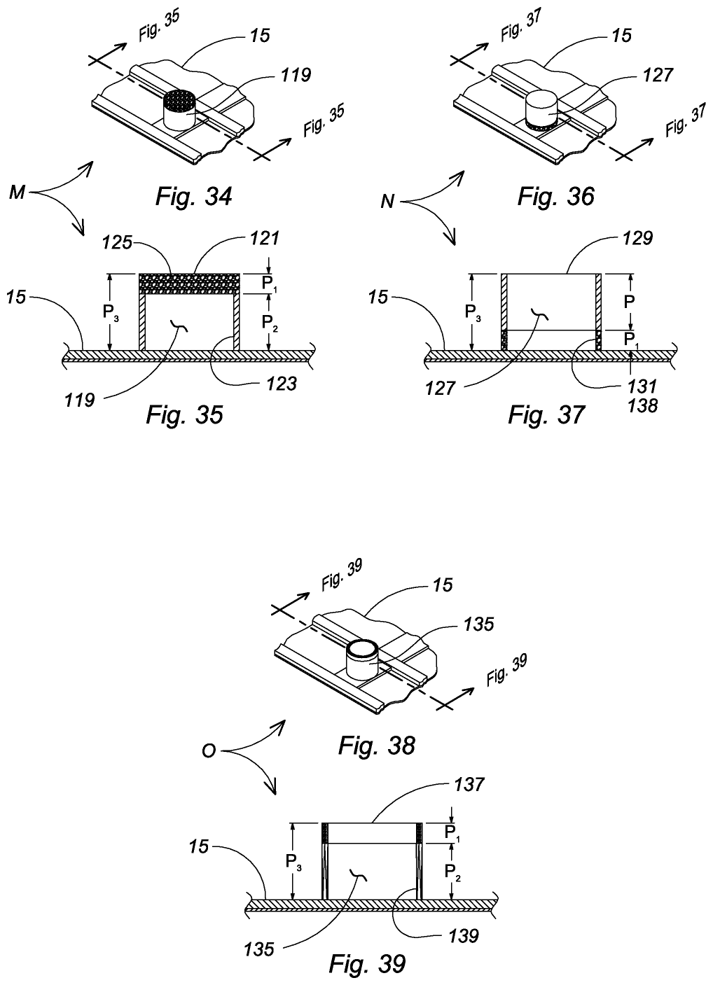

FIG. 34 and FIG. 35 show a 13^{th} embodiment M of the present invention comprising a substrate 15 similar to the substrate of FIG. 6 & FIG. 7, but this embodiment comprises a 13^{th} plurality of spring elements 119 having a different configuration and design. More specifically, the plurality of spring elements 119 comprises a 13^{th} first portion 121 and a 13^{th} second portion 123 wherein the 13^{th} first portion has a different stiffness and flexibility than the 13^{th} second portion due to the size and geometric differences between the shape and the material of the 13^{th} first portion 121 and the 13^{th} second portion 123.

In the present embodiment, the 13^{th} first portion 121 comprises a disc-shaped element 125 having certain specific elastic and resiliency characteristics as may be defined by the specific application of this embodiment. The disc-shaped element is sized and shaped to rest upon the top surface of the 13^{th} second portion. The 13^{th} second portion is made from an elastomeric or plastic material that has a different resiliency than the material of the disc-shaped element 125. It is understood that the difference in resiliency and stiffness between the 13^{th} first portion 121 and the 13^{th} second portion 123 makes the 13^{th} first portion capable of greater sound attenuation for certain frequencies and types of sounds than the 13^{th} second portion 33. The result is a spring element design that again has the effect of a compound spring design. The other general specifications and descriptions for the present embodiment are substantially the same as those noted and described in the first embodiment above.

FIG. 36 and FIG. 37 show a 14^{th} embodiment N of the present invention comprising a substrate 15 similar to the substrate of FIG. 6 & FIG. 7, but this embodiment comprises a 14^{th} plurality of spring elements 127 having a different configuration and design. More specifically, the 14^{th} plurality of spring elements 127 comprises a 14^{th} first portion 129 and a 14^{th} second portion 131 wherein the 14^{th} first portion has a different stiffness and flexibility than the 14^{th} second portion due to the material property differences between the 14^{th} first portion 129 and the 14^{th} second portion 131.

In the present embodiment, the 14^{th} first portion 129 is generally tubular in shape and has a wall thickness that is substantially the same as the wall thickness of the 14^{th} second portion 131. It is understood, however, that 14^{th} second portion 131 comprises a 2^{nd} foam element 133 in the general shape of a ring. In contrast to the other embodiment noted above, it is the 14^{th} second portion of this embodiment that is more flexible and resilient than the 14^{th} first portion 129. Therefore, the 14^{th} first portion 131 is capable of sound attenuation for certain frequencies and types of sound that are different than that of the 14^{th} second portion 131. The result is a spring element design that again has the effect of a compound spring design. The other general specifications and descriptions for the present embodiment are substantially the same as those noted and described in the first embodiment above.

FIG. 38 and FIG. 39 show a 15^{th} embodiment 0 of the present invention comprising a substrate 15 similar to the substrate of FIG. 6 & FIG. 7, but this embodiment comprises a 15^{th} plurality of spring elements 135 having a different configuration and design. The 15^{th} plurality of spring elements 135 comprises a 15^{th} first portion 137 and a 15^{th} second portion 139 wherein the 15^{th} first portion has a different stiffness and flexibility than the 15^{th} second portion due to the difference in the average material compositions between the 15^{th} first portion and the 15^{th} second portion. More specifically, the 15^{th} first portion 137 is substantially made from a more flexible and resilient material than the average material composition of the 15^{th} second portion. As can be seen in FIG. 39, the 15^{th} second portion is made from a material that gradually combines with the material of the 15^{th} first portion as the two portions combine to reach the P₃ overall height of each of the 15^{th} plurality of spring elements. Those of skill in the art understand that this type of material change can be accomplished during a co-extrusion process where one material and a second material are forced through an extrusion die. Thus, while the 15^{th} plurality of spring elements is essentially one integrated element, the average material composition of the 15^{th} first portion 137 is not the same as the average material composition of the 15^{th} second portion. It is understood that processes other than co-extrusion can also be used to manufacture the combined 15^{th} first portion 137 and the 15^{th} second portion 139.

It is noted that the differences between the resiliency and the stiffness of the average material of the 15^{th} first portion and the average material composition of the 15^{th} second portion makes the 15^{th} first portion capable of different types of sound attenuation for certain frequencies and types of sounds than does the average material composition of the 15^{th} second portion. The result is a spring element design that again has the effect of a compound spring design. The other general specifications and descriptions for the present embodiment are substantially the same as those noted and described in the first embodiment above.

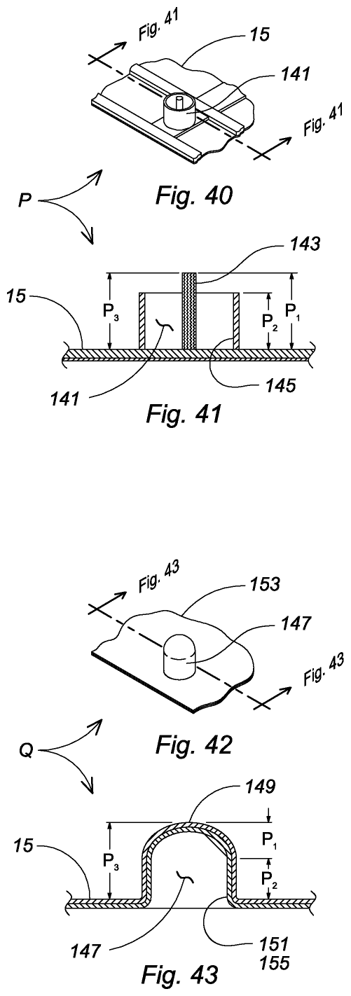

FIG. 40 and FIG. 41 show a 16^{th} embodiment P of the present invention comprising a substrate 15 similar to the substrate of FIG. 6 & FIG. 7, but this embodiment comprises a 16^{th} plurality of spring elements 141 having a different configuration and design. The 16^{th} plurality of spring elements 141 incorporates a two-element design that function in a manner similar that of the previous embodiments.

More specifically, 16^{th} plurality of spring elements 141 comprise two concentrically oriented elements of a rod 143 disposed centrally inside a cylinder 145. The rod 143 is made from a material that is more resilient and flexible than the material used to make the cylinder 145. As weight loads and sound loads are placed upon the rod 143, the ability of the rod will be less capable of sound attenuation than the cylinder 145. Thus, although the geometric placement and configuration of the elements of this 16^{th} embodiment are slightly different than the previous embodiments, the effect is that of a spring element design that again has the effect of a compound spring design. The other general specifications and descriptions for the present embodiment are substantially the same as those noted and described in the first embodiment above.

FIG. 42 and FIG. 43 show a 17^{th} embodiment Q of the present invention comprising a substrate 15 similar to the substrate of FIG. 6 & FIG. 7, but this embodiment comprises a 17^{th} plurality of spring elements 147 having a different configuration and design. More specifically, the 17^{th} plurality of spring elements 147 comprises a bulbous portion 149 and a 2^{nd} portion wherein the bulbous portion is disposed upon the 2^{nd} portion and where the bulbous portion is essentially integrated with the 2^{nd} portion. It is also noted that while previous embodiments incorporated a substrate like that of the first embodiment herein, the present embodiment is different in that integrated bulbous portion 149 and the 2^{nd} portion can be made from a substantially continuous sheet of the polymeric material and press-formed by tooling to generate the 17^{th} spring elements 147 into the substantially continuous sheet of polymeric material.

It is understood that the vertical walls 155 of the 2^{nd} portion 151 can support a greater load than the bulbous portion 149 and that the bulbous portion has a different resiliency than the 2^{nd} cylindrical portion thereby making the bulbous portion 149 more capable of greater sound attenuation for certain frequencies and types of sounds than does the vertical walls 155 of the 2^{nd} portion. The result is a spring element design that again has the effect of a compound spring design. The other general specifications and descriptions for the present embodiment are substantially the same as those noted and described in the first embodiment above.

In the preceding description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill. The scope of the invention should be determined by any appended claims and their legal equivalents, rather than by the examples given.

Additionally, it will be seen in the above disclosure that several of the intended purposes of the invention are achieved, and other advantageous and useful results are attained. As various changes could be made in the above constructions without departing from the scope of the invention, it is intended that all matter contained in the above descriptions or shown in the accompanying drawings shall be interpreted as illustrative and not in a limiting sense.

Terms such as “proximate,” “distal,” “upper,” “lower,” “inner,” “outer,” “inwardly,” “outwardly,” “exterior,” “interior,” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed. It will also be understood that when an element is referred to as being “operatively connected,” “connected,” “coupled,” “engaged,” or “engageable” to and/or with another element, it can be directly connected, coupled, engaged, engageable to and/or with the other element or intervening elements may be present. In contrast, when an element is referred to as being “directly connected,” “directly coupled,” “directly engaged,” or “directly engageable” to another element, there are no intervening elements present. Other words used to describe the relationship between elements should be interpreted in a like fashion (e.g., “between” versus “directly between,” “adjacent” versus “directly adjacent,” etc.).

What is claimed is:

1. An acoustic attenuation mat comprising:
a plurality of spring elements disposed upon a substrate;
wherein the plurality of spring elements further comprises a first portion and a second portion;
wherein the first portion has a spring rate that is different than the spring rate of the second portion;
wherein the first portion and the second portion generate a variable rate compound spring system when subjected to at least one of either a static, a dynamic, a vibratory, and an acoustic load;
wherein each of the plurality of spring elements has an overall height of P₃, wherein the first portion has a height of P₁, and wherein the second portion has a height of P₂; and,
wherein the substrate and the plurality of spring elements are constructed of at least one of a synthetic material, a natural material, and a viscoelastic material.

2. The acoustic attenuation mat of claim 1 wherein each of the plurality of spring elements wherein the first portion includes a plurality of support elements having an upper surface, an angular element, and a lower surface, wherein each of the plurality of spring elements has a shape that is one of either a hollow tube shape or a solid rod shape, and wherein the tube shape is one of either a cylindrical shape, a square shape, a rectangular shape, a polygonal shape, an oval shape, an arcuate shape, or an irregular shape.

3. The acoustic attenuation mat of claim 1 wherein the first portion and the second portion that have a tube shape, and wherein the first portion has a first wall thickness size that is less than a second wall thickness size of the second portion.

4. The acoustic attenuation mat of claim 1 wherein the first portion has a tube shape with a tapered wall thickness extending downward from a vertex to the second portion such that the tapered wall thickness of the first portion progressively increases in thickness downwardly until the tapered wall thickness of the first portion is essentially the same as the wall thickness of the second portion where the first portion meets the second portion.

5. The acoustic attenuation mat of claim 1 wherein the first portion is generally ring-shaped and is made from an elastomeric material that has a different resiliency than the material used for the second portion, wherein the first portion has a cross section shape that is one of either a circle, a toroid, a polygon, or an irregular shape, and wherein the second portion wherein the cross section of the second portion is one of either a regular geometric shape or an irregular shape.

6. The acoustic attenuation mat of claim 1 wherein the first portion is generally tubular in shape and includes a plurality of rectangular notches, and wherein the cross section of the second portion is one of either a regular geometric shape or an irregular shape.

7. The acoustic attenuation mat of claim 1 wherein the first portion is generally bulbous-shaped having a substantially flat upper bulb portion that rests upon the second portion shape, wherein the entire bulbous shape has a wall thickness in the normal direction that is one of either thinner, thicker, and the same thickness as the wall thickness of the second portion, and wherein the cross section of the second portion is one of either a regular geometric shape or an irregular shape.

8. The acoustic attenuation mat of claim 1 wherein the first portion is generally arcuately-shaped having a substantially arcuate upper portion that rests upon the second portion, and wherein the cross section of the second portion is one of either a regular geometric shape or an irregular shape.

9. The acoustic attenuation mat of claim 1 wherein each of the plurality of spring elements has a horizontal cross section substantially in the form of a cross having a set of arms, wherein each of the arms has a notch, wherein the second portion also has a set of arms, wherein each of the arms does not have a notch.

10. The acoustic attenuation mat of claim 1 wherein the first portion comprises a plurality of protrusions that are disposed upon an upper surface of the second portion, wherein each of the plurality of protrusions has a cross section that is at least one of either a cylindrical shape, a square shape, a rectangular shape, a polygonal shape, an oval shape, an arcuate shape, or an irregular shape, and wherein the cross section of the second portion is one of either a regular geometric shape or an irregular shape.

11. The acoustic attenuation mat of claim 1 wherein the first portion generally comprises a quantity of elastomeric material having an irregular shape, but being sized to rest upon the second portion, wherein the elastomeric material has a different resiliency than the material of the second portion, and wherein the cross section of the second portion is one of either a regular geometric shape or an irregular shape.

12. The acoustic attenuation mat of claim 1 wherein the first portion comprises a base and a support, wherein the support resides on an upper face of the base such that the support makes an obtuse angle with the base, and wherein the support has a cross sectional area that is one of either the same or different cross sectional area of the base.

13. The acoustic attenuation mat of claim wherein each of the plurality of spring elements is generally U-shaped, wherein the first portion comprises the arcuate portion of the U-shape, and wherein the second portion comprises the vertical portions of the U-shape,

14. The acoustic attenuation mat of claim 1 wherein the first portion comprises a shaped foam element having a lower different resiliency than the second portion, wherein the foam element is sized and shaped to rest upon a top surface of the second portion, and wherein the second portion is made from a material that has a different stiffness and flexibility than the foam element.

15. The acoustic attenuation mat of claim 1 wherein the first portion is one of either a geometric shape and an irregular shape and has a wall thickness that is substantially the same as the wall thickness of the second portion, and wherein the second portion comprises a second foam element such that the second foam element is more flexible and resilient than the material of first portion.

16. The acoustic attenuation mat of claim 1 wherein the first portion is substantially made from an average material composition that is different in resiliency than the average material composition of the second portion, wherein the second portion is made from a material that progressively combines with the material of the first portion as the two portions combine to reach the overall height P₃ of each of the plurality of spring elements.

17. The acoustic attenuation mat of claim 1 wherein each of the plurality of spring elements comprise two substantially concentrically oriented elements of a rod disposed inside a cylinder, wherein the rod is made from a material that has a different resiliency than the material of the cylinder, wherein the rod and the cylinder have a cross section that is one of either a regular geometric shape or an irregular shape.

18. The acoustic attenuation mat of claim 1 wherein each of the plurality of spring elements comprises a bulbous portion disposed upon the second portions, wherein the bulbous portion is essentially integrated with the second portion and the substrate, and wherein the bulbous portion has a different resiliency that the substrate.
